(19) United States
(12) Patent Application Publication
(10) Pub. No.: US 2010/0044287 A1
(43) Pub. Date: Feb. 25, 2010

(54) HYDRO CYCLONE DEVICE AND HYDRO CYCLONE INSTALLATION

(76) Inventor: Holger Blum, Teufen (CH)

Correspondence Address: NIXON PEABODY, LLP, 401 9TH STREET, NW, SUITE 900, WASHINGTON, DC, 20004-2128, US

(21) Appl. No.: 12/528,072

(22) PCT Filed: Nov. 28, 2007
(86) PCT No.: PCT/EP07/10333

§ 371 Date: Aug. 20, 2009

(30) Foreign Application Priority Data
Feb. 21, 2007 (DE) 20 2007 002 541.6

(51) Int. Cl. B01D 29/60; B01D 21/26; B01D 36/00; B01D 29/88

(52) U.S. Cl. 210/97; 210/306

(57) ABSTRACT

A hydro cyclone device comprises a vertical separator tube (T) having an upper opening for the liquid supply and its upper front side (O) and an opening for the clear water drainage at its lower front side (U), at least a port (O) for concentrated suspension and the lower end of the separator tube (T) as well as a filter element (F) hydraulically connected to the clear water drainage and arranged centred in the separator tube (T). In the separator tube (T) between the upper opening (O) for the liquid supply and the filter element (F), a rotational element (R) is arranged axially centred with respect to the separator tube and rotationally supported which filter element is adapted to be driven an variable rotational speed. Hydro cyclone installation comprises a plurality of such hydro cyclone devices being hydraulically connected in parallel.

The invention relates to a hydro cyclone device comprising a vertical separator tube haven an upper opening for a liquid supply at its upper front side and an opening for a clear liquid drainage at its lower front side, at least a port for concentrated suspension at the lower end of the separator tube as well as a filter element hydraulically connected to the clear liquid drainage and being centred in the separator tube, as well as to a hydro cyclone installation comprising a plurality of such hydro cyclone devices.

### BACKGROUND OF THE INVENTION

A conventional hydro cyclone is composed out of three essential components, a conical separator tube being a lower drainage port for the concentrated suspension, a supply port tangentially arranged at the upper end of the separator tube and an upper closure cover of the separator tube having a discharge port for the clear water drainage which port extends into the separator tube, as axially centred therewith and is directed upwards.

The separation of the suspended particle present in the supply liquid is effected up to a minimal drain diameter dk depending on a number of process parameters. These parameters are a) the diameter of the supply port, b) the viscosity of the carrier liquid, c) the density difference between the suspended material and the carrier liquid, d) the ratio of the volume flows of the clear liquid to the liquid supply, e) the upper diameter of the separator tube, f) the volume flow of the supply liquid and g) the value of the cone angle. This has been described by D. Bradley in “The Hydro cyclone” Pergamon Press, London 1965.

Because of the above mentioned processing relationship it is not possible to arbitrarily enlarge the diameter of the hydro cyclone given a particular volume flow of the supply liquid if one would like to achieve a precise separation of suspended particles up to a maximum grain diameter. Therefore, one is forced to connect several hydro cyclones in parallel and to supply them with supply suspension from a common manifold tube. Each one of the parallel connected hydro cyclones in such a separator installation presents a hydraulic resistance to the supplied suspension.

In case several hydro cyclones are connected to a straight manifold tube, one after the other, a pressure difference builds up in the manifold tube from the first to the last hydro cyclone, and, therefore, the volume flow of supply liquid to each of the single hydro cyclones is different. Consequently, the result of the separation in such a hydro cyclone installation is not unitary.

In order to forcedly achieve a larger uniformity, one has tried to connect the individual hydro cyclones of the hydro cyclone installation to a common ring tube or to connect them radially to a common supply container. This measurement, at first, results in a sufficient uniformity. In the course of the operation, however, interior non-uniformities of the hydraulic resistance in the hydro cyclones occur resulting from depositions within the separator tube. Therefore, also in the operation with ring tubes or central supply containers, one is forced to interrupt the continuous operation by frequent flushing in an oblige direction and a backwards direction, and to adjust the hydro cyclone installation anew after each start up procedure.

One has also tried to forcedly achieve a unitary hydraulic resistance of the single hydro cyclones by means of valve control at the clear liquid drainage and/or at the drainage of the concentrated suspension. This measure, however, leads to a steep raise of the energy consumption of the feed pump as well as to the occurrence of cyclic variations related to the purity or the separation accuracy respectively of the clear fluid drainage.

The above mentioned problems in operating a hydro cyclone installation are further aggravated when the installation is not installed stationary but is installed on platform which is moving or is not exactly adjusted to the horizontal direction. Examples for that are disposal vehicles which purify waist water during travelling, or hydro cyclone installations in containers which start their operation while positioned on sloping sites. A further example is the operation of a hydro cyclone installation on ships for ballast water treatment.

### SUMMARY OF THE INVENTION

It is the object of the invention to provide a hydro cyclone device in which the correct, uniform separation efficiency is guaranteed also when interconnecting devices to built a hydro cyclone separator installation and/or in operation on vehicles.

For achieving this object, the hydro cyclone device according to the invention is characterized in that, in the separator tube between the upper opening of the liquid supply and the filter element, a rotational element is arranged which is axially centred to the separator tube and is rotatably supported the rotational element being adapted to be driven at variable rotational speed. In spite of this simple construction, an extremely reliable and undisturbed separation of the liquids with the spended solid particles in the clear liquid drainage and the concentrated suspension is achieved. Furthermore, the device is controllable in a simple way when installed.

A further security against unusual operational situations consists in that the hydro cyclone controllable according to the invention, is not affected to a large extend by deviations of the separator tube from the vertical position during operation. It is particularly surprising and important to note that, in the inventive installation of the cyclone, also the tendency of haze formation of the clear liquid drainage can be avoided to a large extend even in the case of an intermittence liquid supply.

Because of the compact installation and the easy controllability of the efficiency by means of variation of the rotational speed, the operation and maintenance effort is rather small and results only in a minimum of hydraulic energy consumption because control valves in the supply of the inventive hydro cyclone are eliminated. Furthermore, a small food print of the hydro cyclone installation of the invention is achieved since a lot of space can be saved in between the single separation tubes.

According to an advantageous embodiment of the invention, the filter element is a hollow cylinder which is closed at its upper front side and is also formed as a filter surface, i.e. a so called cartridge filter, providing a good throughput and also good filter efficiency.

According to an advantage embodiment of the invention, the separator tube has a cylindrical wall. Since no conical separator tube is necessary in this hydro cyclone device, the manufacture of the device is considerably simplified by using standard tubes out of steel, high-grade steel, plastics material or other materials.

According to an advantageous embodiment of the invention, the rotational element has a cup-shape with a cylindrical wall or a conical wall having an increasing diameter from top to bottom or a bell-shape open at the bottom, whereby the best efficiency of the rotational element is achieved by means of the bell shape.

According to an advantageous embodiment of the invention, the end of the rotational element adjacent to the cartridge filter, has about the 0.6-fold to 0.4-fold diameter of the separator tube and corresponds approximately to the diameter of the filter element.

The ratio of the length of the rotational element to its diameter is about 1:1 to about 2:1. The rotational element can consist out of metal or plastics or out of a compound material. If used in seawater, the rotational element preferably consists out of a high-grade steel or a copper-nickel alloy.

The hydro cyclone installation according to the invention is, furthermore, characterized by a plurality of hydro cyclone device of the above kind, connected hydraulically in parallel which is in particular advantageous in the case a large liquid throughput is desired.

According to an advantageous embodiment of the invention each hydro cyclone device has its own drive motor for the rotational element such that the controllable hydro cyclones interconnected to form a hydro cyclone installation, may be controlled separately whereby the amount of clear liquid discharged from the hydro cyclone installation and the haziness thereof maybe advantageously controlled in a flexible way.

According to a preferred embodiment of the invention, an electric motor controlled by a frequency converter, serves for driving the rotational element whereby an effective control of the rotational speed of the rotational element is achieved and the control of the hydro cyclone device of the invention can be carried out by analog or digital computer systems in a simple way.

According to an advantageous embodiment of the invention a control unit is provided configured to control the rotational speed of the respective rotational element depending on the process parameters of the respective hydro cyclone device.

According to advantageous embodiment of the invention, the process parameters are one or several of the parameters haziness of the liquid drainage, pressure in the separator tube, pressure difference between supply pressure and pressure in the separator tube and volume flow.

According to an advantageous embodiment of the invention, the control unit based on the pressure difference comprises at least two pressure sensors and a measurement converter which is configured to determine the pressure difference from the measurement values of the pressure sensors, to carry out a comparison of measured values and nominal values, and to output a resulting control signal to the speed control of the motor.

A further understanding of the nature and advantages of the embodiments of the present invention may be realized by reference to the remaining portions of the specification and the drawings.

### BRIEF DESCRIPTION OF THE DRAWINGS

FIG. 1 schematically shows a controllable hydro cyclone device with a rotational element having the form of a bell,

FIG. 2 schematically shows a controllable hydro cyclone device with a rotational element in the shape of a cup with a conical wall;

FIG. 3 schematically shows the controllable hydro cyclone device with a rotational element in the form of a cup with a cylindrical wall;

FIG. 4 shows a hydro cyclone installation consisting of two single hydro cyclone devices.

### DESCRIPTION OF THE SPECIFIC EMBODIMENTS

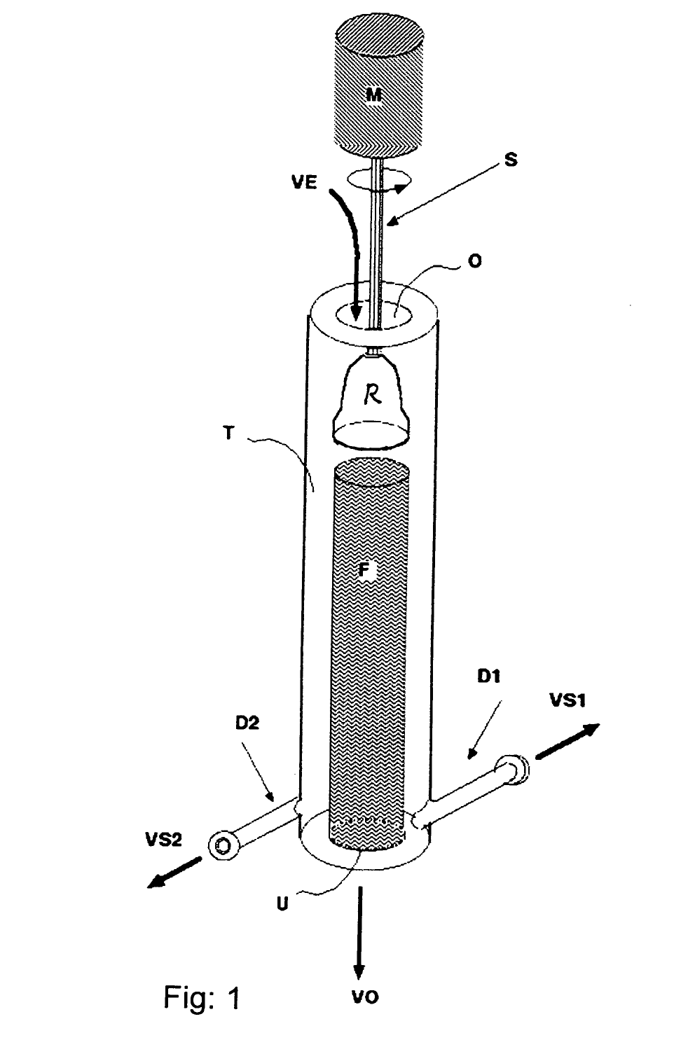

As can be seen from the FIG. 1, the suspension flow VE (volume/unit of time) to be separated flows through the central upper opening O in the separator tube T and flows downwards past the rotational element R. Thereby, a tangential, rotational component is forcedly applied to the flow VE. The rotational element R is connected to the drive motor M through shaft S.

A portion of the upwardly flowing suspension VE is divided within the separator tube T into the clear liquid drainage VO flowing through the cartridge filter F and is charging through des lower opening U. The suspended particles the specific weight of which is larger than that of the carrier liquid, are collected mainly at the wall of the separator tube T and form the partial flows VS1 und VS2 of the concentrated suspension. The partial flows VS1 and VS2 are discharged through the tube stubs D1 and D2 tangentially arranged at the lower end of the separator tube.

The rotational speed of the rotational element R is variable in that, for example, the drive motor M is a three-phase motor the rotational speed of which is controlled by means of a frequency converter. Because of the possibility to vary the rotational speed of the rotational element R during operation, not only the separation efficiency of the hydro cyclone device but also the hydraulic overall resistance between the inlet opening O and the outlet opening U may be influenced. Because of this control, the hydro cyclone device is particularly suited for building hydro cyclone installations based on a plurality of hydro cyclones of the inventive kind connected in parallel.

As can be seen, it is a further advantage of this controllable hydro cyclone device that an always uniformly concentrated suspension VS is discharged from the hydro cyclone device also in the case of varying supply flow VE.

It was surprisingly found that if the separator cylinder T is not placed exactly vertical or if the separator cylinder T is moved during operation and deviates by some degrees from the vertical direction, this has no noticeable influence on the separator efficiency of the controllable hydro cyclone. Therefore, the hydro cyclone device is particularly suited for the operation on land vehicles or sea vehicles.

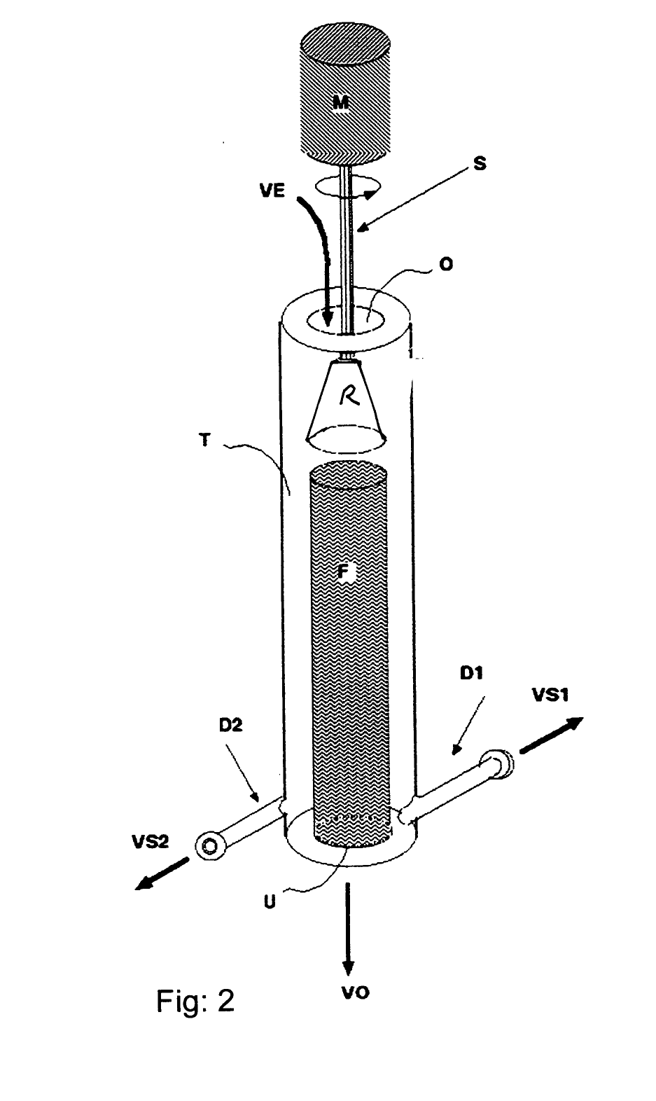

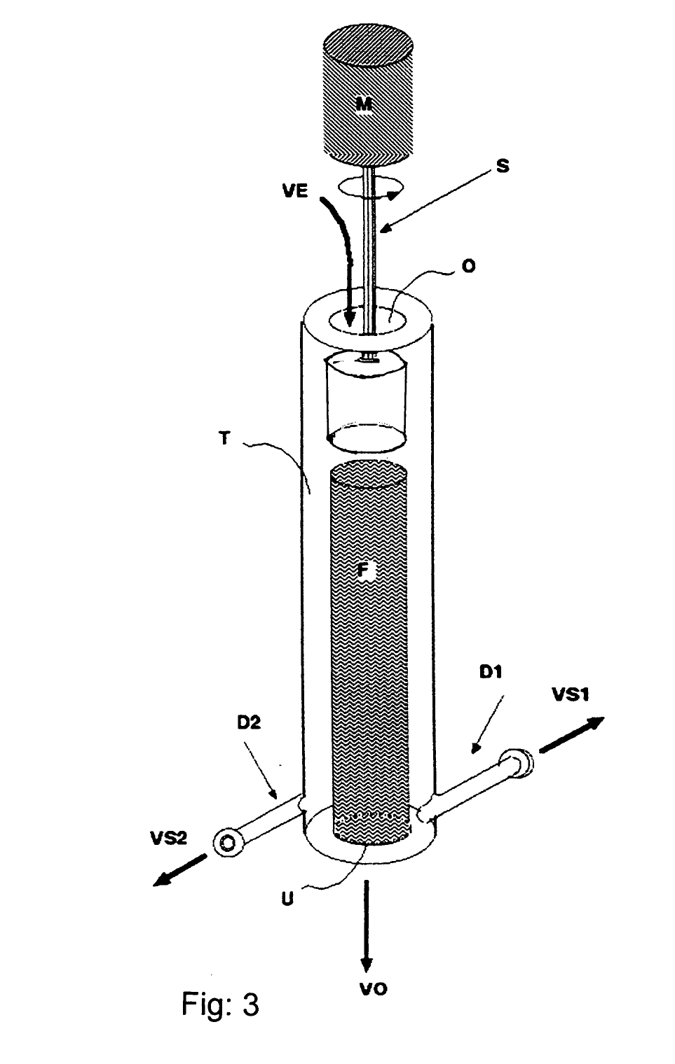

The rotational element R has, in the preferred embodiment, the form of a bell as is shown in FIG. 1. However, also other shapes are effective, for example, the rotational element may have the shape of a cup with a conical wall as is schematically shown in FIG. 2. Alternatively, the rotational element may have the shape of a cup that is a cylindrical wall as is schematically shown in FIG. 3. Accept of the shape of the rotational element, the embodiments of FIGS. 1 and 3 are identical, and, therefore, a new description is not necessary.

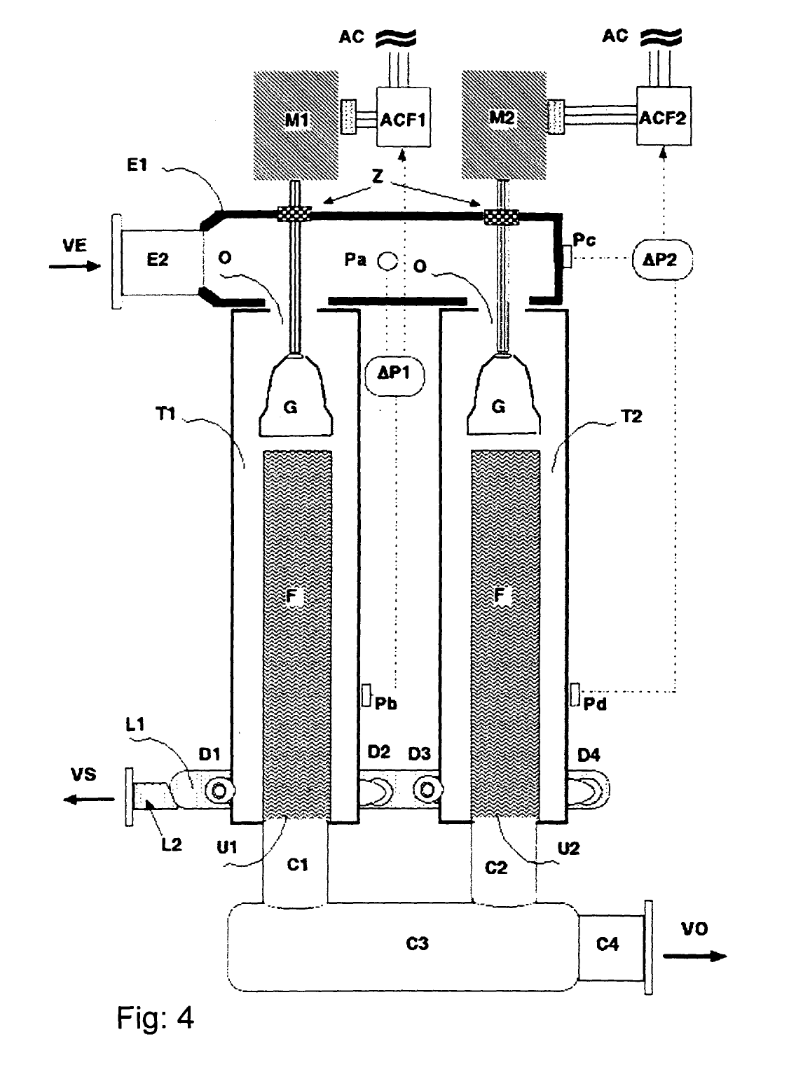

A controllable hydro cyclone separator battery according to the invention comprises a plurality of separator cylinders T standing in parallel next to each other as is shown in FIG. 4. These separator cylinders arranged in parallel to each other, are, for example, applied from a common manifold tube E1 through the flansh E2 with raw suspension VE, and this kind of interconnection of individual separator cylinders of the inventive shape to a hydro cyclone separator battery is advantageous in the case where large water flows of the suspended particles have to separated.

The details of the inventive hydro cyclone separator installation are shown in FIG. 4. According to this figure, the concentrated suspension enters through the tangentially arranged tube stubs D1, D2, D3 and D4 into one or several manifold tubes L1 and leaves the hydro cyclone separator installation as liquid flow VS through the tube flange L2.

In the same way, the clear water flows from the bottom of the filter cartridges F through the openings U1 and U2 out of the separation cylinders T1 and T2 which have the same size, and it gets into the manifold tube C3 through tubes C1 and C2 and leaves the tube flange C4 as clear water flow V0.

The separation cylinders contain bell shaped rotational elements R of the same size which are each driven by a motor. In FIG. 4, the driving means are three-phase motors. The drive shafts for the rotational elements R extend, in the preferred embodiment of the invention, through the liquid manifold head E1 and are sealed against the liquid manifold head E1 by seals Z.

As can be seen from FIG. 4, the rotational speed of the drive motors M1 and M2 are controlled by frequency converters ACF1 and ACF2, respectively. The frequency converters are connected to a common supply current cable AC, and they receive their respective control signal in the form of a signal current, for example 4-20 mA, or in the form of a signal voltage 0 to 5 Volt from the controllers and measurement converters designated in FIG. 4 with Δ-P1 and Δ-P2.

In the preferred embodiment of the invention, each separator cylinder has its own control unit. Each control unit is connected to two pressure sensors Pa and Pb or Pc and Pd, respectively, as can be seen from FIG. 4. The measurement converter Δ-P calculates the differential pressure from the signals input by the pressure sensors Pa, Pb or by the pressure sensors Pc, Pd, respectively, and compares this differential pressure with a predefined nominal value. The deviation of the nominal value and the actual value is output as a control signal to the respective frequency converters ACF1 and ACF2. This control circuit guarantees that the liquid flows from the manifold head E1 to the separator cylinders T1 and T2 are equally distributed and that, therefore, the hydro cyclone separator installation can also be functionally set in the same way as the individual hydro cyclone devices according to the invention.

If the measurement converter controller Δ-P itself is a differential pressure sensor, the measurement sensors Pa, Pb and Pc, Pd are pressure measurement flanges, and the conductors shown in the drawing of FIG. 4 in a broken line and leading to the measurement converter controller Δ-P are metal tubes are hose tubes.

The measurement sensor pairs Pa, Pb and Pc, Pd, respectively, may be fixed at different positions on the separator cylinder T or outside thereof. The measurement locations shown in FIG. 4 are only possible configurations of the measurement locations.

The operation of the complete hydro cyclone separator installation is controlled without valves, only by means of the rotational element. The hydro cyclone installation according to the invention may contain three, four or more separator cylinders instead of two separator cylinders D1 and D2 without adversely affecting the separation accuracy and the throughput of the apparatus.

### Example 1

For comparing the rotational element of the invention with other rotational bodies, a filter cartridge with a length of 800 mm and a grade of 40 μm and an outer diameter of 90 mm was used in a separator cylinder having a length of 1050 mm and an outer diameter of 168.33 mm. The filter cartridge which was open at the bottom, was connected to the clear water drainage U, a tube stub with an outer diameter of 88.9 mm. The separator cylinder had two tangentially extending tube portions with a diameter of ⅜ inch at its lower ends, one of which was used for the pressure measurement location for the pressure sensor Pb.

The separator cylinder had an upper circular supply opening O of a diameter of 92 mm to which a 90-degree-DIN-tube bend with an outer diameter of 88.9 mm was flanged. The measurement location of the measurement sensor Pa was placed on the outside of the tube bend at 45 degree peripheral angle. The driving shaft for the rotational body having a diameter of 19 mm, extended through this tube bend, was sealed against the same by means of a phase seal and extended through the supply opening O.

The three rotational bodies, a cup open at the bottom, a steel sheet cone and the bell each had an outer diameter of 88.9 mm and a length of 160 mm, and they were arranged with their lower open side by 20 mm above the filter cartridge F coaxially arranged therewith.

The measurement sensors Pa and Pb were connected to a differential pressure measurement instrument. The three-phase motor with the parameters 2800 rpm and 0.75 kW, was supplied by a frequency converter connected to the mains. At the frequency converter, the rotational speed could be displayed and could be controlled by means of a potentiometer.

Water was pumped through the hydro cyclone by means of a rotational pump. The ratio of the supply flow VE to the drainage flow VS through the ¾ inch tube stub arranged tangentially at the lower end of the separator tube, was adjusted to 25.

If the pressure difference at the sensors Pb, Pa in the separator cylinder is measured without installed rotational body at different flow rates, a negative value (pressure drop) is encountered. By means of installing the rotational body, the pressure drop becomes smaller or positive, respectively, in relative calculation. The largest effect is achieved by the bell shape, followed by the cone shape. The smallest effect is provided by the cup shape, the relative pressure raise of which is taken as reference value 1 in the following table 1.

TABLE 1
Relative pressure rise between Pa and Pb

| Flow rate VE | Rotational body | | |
|---|---|---|---|
| m³/h | cup | cone | bell |
| 60 | 1 | 1.4 | 3.0 |
| 80 | 1 | 1.5 | 2.8 |
| 100 | 1 | 1.5 | 2.6 |

As can be seen from Table 1, the effect of the bell shaped, axially centred rotational element depends only to a small extend from the flow rate that is clearly superior to the other shapes of the rotational body shown as a comparison.

### Example 2

The hydro cyclone device according to the invention of Example 1 with an installed bell shaped rotational element having an outer diameter of 88.9 mm had a supply rate VE of 80 m³/h of a suspension of 1% titan oxide with a grade of 2 μm and silica with a grade of 30 μm in a weight ratio of 1:1. The carrier medium water contained additionally 100 ppm guar-biopolymer. The lower drainage VS was adjusted to 5% of the supply flow VE. The three-phase motor was adjusted to an energy consumption of 680 Watt.

The whole cyclone device was movably suspended in a frame such that tilting of the same about the vertical axis of the separator tube was possible by means of a motor driven ex-center device. The supply and discharge of the liquid flows was affected through hoses.

The described hydro cyclone device was tilted by plus/minus 5 degrees with a tilting frequency of 0.5 Hertz with respect to vertical.

Herein, the cyclone device prepared in this way, was operated in the following sequence: 90 minutes in 0.5 Hertz tilting operation followed by 90 minutes stationary operation (no variation or tilting from the vertical respectively).

The influence on the separation accuracy (haziness of the clear water drainage) could not be observed during a total operation time of 6 hours.

### Example 3

The experiment of example 2 was repeated with a rotational element R embodied by the cone open at the bottom which was subject to example 1 and had a length of 160 mm and an outer diameter of 88.9 mm. Herein, a substantial increase of the haziness of the clear water drainage was observed during a period of 90 minutes with 0.5 Hertz tilting operation as compared to the examination period of 90 minutes with stationary separator tube.

It is to be understood that the above description is intended to be illustrative and not restrictive. Many embodiments will be apparent to those skilled in the art upon reviewing the above description. The scope of the invention should, therefore, be determined not as reference to the above description, but should instead be determined with reference to the appended claims along with the full scope of equivalence to which such claims are entitled.

What is claimed is:

1-14. (canceled)

15. A hydro cyclone device comprising:
a vertical separator tube having an upper opening for the liquid supply and a lower opening for the clear water drainage,
at least a port for concentrated suspension at the lower end of the separator tube, and
a filter element hydraulically connected to the clear water drainage and arranged centred in the separator tube, wherein,
in the separator tube between the upper opening for the liquid supply and the filter element, a rotational element is arranged axially centred with respect to the separator tube which rotational element is adapted to be driven at a variable rotational speed.

16. Device according to claim 15, wherein in that the filter element comprises a hollow cylinder which is closed at its upper front side or is also formed as a filter surface.

17. Device according to claim 15, wherein the separator tube comprises a cylindrical wall.

18. Device according to claim 15, wherein the rotational element comprises a cup shape with a cylindrical wall.

19. Device according to claim 15, wherein the rotational element comprises a conical wall having a diameter becoming larger from the top to the bottom

20. Device according to claim 15, wherein the rotational element comprises a bell shape open at the bottom.

21. Device according to claim 15, wherein the end of the rotational element facing the filter element has approximately a 0.6-fold to 0.4-fold diameter of the separator tube and corresponds to the diameter of the filter element.

22. Device according to claim 15, wherein the ratio of the length of the rotational element to the diameter thereof is approximately 1:1 to approximately 2:1.

23. Device according to claim 15, wherein the drive shaft for the rotational element extends from above through the opening of the liquid supply and the upper front side of the separator tube.

24. Device according to claim 15, wherein an electric motor controlled by a frequency converter serves as a driving means for the rotating element.

25. Device according to claim 15, comprising a control unit configured to control the rotational speed of the respective rotational element depending on the process parameters of the respective hydro cyclone device.

26. Device according to claim 25, wherein the process parameters comprise one or more of the parameters: haziness of the clear liquid drainage, pressure in the separator tube, pressure difference between supply flow and pressure in the separator tube and the volume stream.

27. Device according to claim 26, wherein the control unit based on the pressure differential comprises at least two pressure sensors and a measurement converter configured to determine the pressure difference between the measurement values of the pressure sensors, to carry out a nominal value to actual value comparison and to output a resulting control signal to the rotational speed control unit of the motor.

28. Hydro cyclone installation comprising a plurality of hydro cyclone devices each device comprising:
a vertical separator tube having an upper opening for the liquid supply and a lower opening for the clear water drainage,
at least a port for concentrated suspension at the lower end of the separator tube, and
a filter element hydraulically connected to the clear water drainage and arranged centred in the separator tube, wherein,
in the separator tube between the upper opening for the liquid supply and the filter element, a rotational element is arranged axially centred with respect to the separator tube which rotational element is adapted to be driven at a variable rotational speed.

29. Hydro cyclone installation according to claim 28, wherein each hydro cyclone device comprises its own drive motor for the rotational element.

30. Hydro cyclone installation according to claim 28, wherein an electric motor controlled by a frequency converter serves as a driving means for the rotating element.

31. Hydro cyclone installation according to claim 28, comprising a control unit configured to control the rotational speed of the respective rotational element depending on the process parameters of the respective hydro cyclone device.

32. Hydro cyclone installation according to claim 31, wherein the process parameters comprise one or more of the parameters: haziness of the clear liquid drainage, pressure in the separator tube, pressure difference between supply flow and pressure in the separator tube and the volume stream.

33. Hydro cyclone installation according to claim 32, wherein the control unit based on the pressure differential comprises at least two pressure sensors and a measurement converter configured to determine the pressure difference between the measurement values of the pressure sensors, to carry out a comparison between a nominal value and an actual value and to output a resulting control signal to the rotational speed control unit of the motor.
